(19) United States
(12) Patent Application Publication
(10) Pub. No.: US 2006/0036786 A1
(43) Pub. Date: Feb. 16, 2006

(54) Logical remapping of storage devices

(76) Inventors: Barrett Kreiner, Norcross, GA (US); Ronald Perrella, Norcross, GA (US); Jonathan Reeves, Roswell, GA (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/918,304

(22) Filed: Aug. 13, 2004

(51) Int. Cl. G06F 13/12

(52) U.S. Cl. 710/62

(57) ABSTRACT

A plurality of storage device communication protocols, used by a corresponding plurality of storage devices, are translated to a single network protocol via an interface in communication with the storage devices. Information is communicated between the plurality of storage devices using the corresponding plurality of communication protocols and an external device via the single network protocol.

### BACKGROUND

The present invention relates generally and in various embodiments to apparatuses, systems, and methods for logically remapping storage devices within a storage area network. More specifically, the present invention relates generally and in various embodiments to apparatuses, systems, and methods for logically remapping a plurality of storage devices associated with a plurality of storage area networks.

Current information storage solutions using existing information storage technologies are inflexible, expensive, and quickly become obsolete as new storage technologies arise. Furthermore, existing storage technologies are monolithic devices. These information storage technologies include hard disk drives, magnetic tape drives, integrated drive electronics (IDE), hard disk drive interfaces for personal computers (PCs), enhanced integrated drive electronics (EIDE), improved interfaces to the IDE hard disk interface, small computer system interfaces (SCSI), which is a standard intelligent parallel interface for attaching peripheral devices to computers, based on a device independent protocol, and advanced technology attachment (ATA), which is a disk drive interface standard formerly called IDE. The ATA specification is concerned with power and data signal interfaces between the motherboard and the integrated disk controller and drive, and serial ATA. Other existing types of information storage technology include optical disks (e.g., compact disk (CD), compact disk read/write (CDRW), digital video disk (DVD), digital video disk read/write (DVDRW), digital video random access memory (DVDRAM), and laser disk (LD)), random access magnetic technology (e.g., hard disk (HD) and floppy disk drive (FDD)), linear access magnetic technology (e.g., magnetic tape drive), flash storage technology (e.g., compact flash, sandisk), and memory (e.g., random access memory (RAM), synchronized dynamic RAM (SDRAM), RAM disk, and RAM bus).

Designing storage solutions using two or more of various different types of the storage technologies described previously, among others, is very complex and expensive. For example, the addition of a new storage technology to an existing storage area network (SAN) requires the implementation of new cables, connectors, and engineering of the storage frame to integrate and support the new storage technology in the SAN. Therefore, there is a need in the art to standardize a storage frame using a single transport standard and then translate it to the particular standard of the new storage technology being added to the frame. A standardized storage frame would eliminate or minimize the amount of additional cabling, connectors, and engineering effort required to integrate new information storage technologies in an existing storage frame.

### SUMMARY

According to an exemplary embodiment, an interface includes a first portion in communication with a plurality of storage devices, wherein the plurality of storage devices use a plurality of communication protocols to exchange information between the plurality of storage devices and an external device. The interface further includes a second portion in communication with the external device. The interface translates the plurality of protocols to a network protocol prior to transmitting the information to the external device.

According to another embodiment, a system includes a plurality of storage devices for storing information thereon, wherein the plurality of storage devices use a corresponding plurality of communication protocols to transmit the information between the plurality of storage devices and an external device. The system further includes an interface comprising a first portion in communication with the plurality of storage devices. The interface further includes a second portion in communication with the external device. The interface translates the plurality of communication protocols to a network protocol prior to transmitting the information to the external device.

In still another embodiment, a system includes a first storage frame including a plurality of storage device caddies, wherein each device caddy further includes a plurality of storage devices for storing information thereon. The plurality of storage devices use a corresponding plurality of communication protocols to transmit the information between the plurality of storage devices and the first storage frame. The system further includes an interface in communication with the plurality of storage devices. The interface translates the plurality of protocols to a single network protocol prior to transmitting the information to the first storage frame.

In yet another embodiment, a method includes translating a plurality of storage device communication protocols to a single network protocol and communicating information between a plurality of storage devices using a corresponding plurality of communication protocols and an external device via the single network protocol.

Other systems, methods, and/or computer program products according to exemplary embodiments will be or become apparent to one with skill in the art upon examination of the following drawings and detailed description. It is intended that all such additional systems, methods, and/or computer program products be included within this description, be within the scope of the present invention, and be protected by the accompanying claims.

### DESCRIPTION OF THE DRAWINGS

Exemplary embodiments are described herein in conjunction with the following figures, wherein:

FIG. 1 illustrates a storage device caddy according to an exemplary embodiment;

FIG. 2 illustrates a storage frame comprising storage device caddies in accordance with an exemplary embodiment;

FIG. 3 illustrates a storage area network system comprising storage frames and storage device caddies in accordance with an exemplary embodiment;

FIG. 4 illustrates an external storage frame in accordance with an exemplary embodiment; and

FIG. 5 illustrates another external storage frame in accordance with an exemplary embodiment.

### DESCRIPTION

It is to be understood that the figures and descriptions of the various embodiments described herein, among others, have been simplified to illustrate representative elements that are relevant for a clear understanding of apparatuses, systems, and methods for providing a storage frame for storage area networks (SAN). The storage frames contain a plurality of storage devices in a storage device caddy and utilize various storage technologies and protocols. Exemplary embodiments described here are directed to logically remapping the various protocols of the different types of storage devices in the storage device caddy to a single protocol connection to the storage frame and thus to the SAN.

In the various embodiments described in detail herein, apparatuses, systems, and methods are provided for integrating a plurality of storage devices employing various storage technologies in a plurality of storage device caddies within a storage frame. For example, exemplary embodiments relate generally to apparatuses, systems, and methods for providing a storage frame having at least one storage device caddy adapted to receive a plurality of storage devices utilizing various different technologies and protocols and one standard electrical connection and network protocol connection from the storage device caddy to the storage frame and the SAN. This architecture simplifies the internal construction of the storage frame and provides a single form of connection from the storage device caddy to the storage frame and the SAN regardless of the different types of storage devices located in the storage device caddies and the protocols utilized to communicate with them.

It is to be understood that storage frames, storage device caddies, and storage devices and protocols described and/or illustrated herein are provided merely as examples. The illustrated embodiments are described herein merely as examples of apparatuses, systems, and methods that cooperate to improve existing storage networks. Those of ordinary skill in the art will appreciate and readily understand, however, that other elements may be used in conjunction with those describe herein provide additional embodiments.

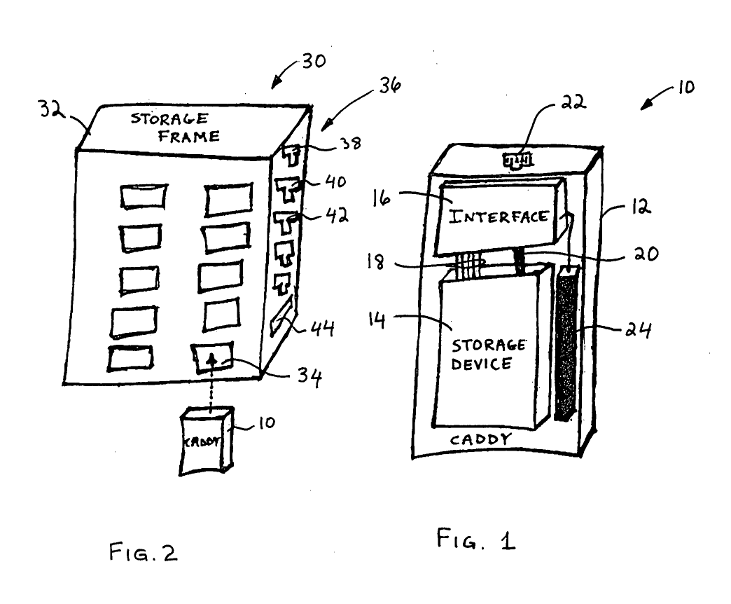

FIG. 1 illustrates one of various embodiments of a storage device caddy 10. The storage device caddy 10 comprises a housing 12, one or more storage devices 14, an interface 16, an interface cable 18 provided at a first portion of the interface 16, a power cable 20, and a connector 22 provided at a second portion of the interface. The storage device caddy 10 also may include a power source, such as, for example, a battery 24. The housing 12 is adapted to interface with a storage frame 30 (see FIG. 2). The housing 12 fits in a drive slot 34 (see FIG. 2) location normally designed to hold a single storage drive in a conventional storage frame. The housing 12 interfaces directly into the drive slot 34 of the storage frame 30 via the connector 22. The storage device caddy 10 is a self supported stand alone logical storage device that can be readily interchanged within a plurality of storage frames 30 comprising a SAN, for example.

According to various embodiments, the storage device 14 comprises, for example, any one or more of the following storage devices: hard disk drive, magnetic tape drive, optical disk technology (e.g., compact disk (CD), compact disk read/write (CDRW), digital video disk (DVD), digital video disk read/write (DVDRW), digital video disk random access memory (DVDRAM), and laser disk (LD)), random access magnetic storage (e.g., hard disk (HD) and floppy disk drive (FDD)), linear access magnetic storage (e.g., magnetic tape drive), flash storage (e.g., compact flash, sandisk), memory (e.g., random access memory (RAM), synchronized dynamic RAM (SDRAM), RAM disk, and RAM bus), for example. Those skilled in the art will appreciate, however, that additional storage devices 14 and technologies, other than the specific examples described herein, may be used. Therefore, the present invention should not be limited to the specific examples and embodiments described herein for illustrative purposes.

According to various embodiments, the interface 16 provides an electrical link for connecting two or more devices and allows a meaningful exchange of information between the two or more devices. The interface 16 is a point of demarcation between the two or more devices where electrical signals, connectors, timing, and handshaking are defined, for example. The interface 16 may be implemented with software, hardware, and/or any combination of hardware/software to allow the two or more devices to communicate in a meaningful manner. According to various embodiments, the interface 16 between the storage device 14 and the storage frame 30 is capable of reading any one of a plurality of protocols in the first portion of the interface 16. The plurality of protocols may include, for example, the integrated drive electronics (IDE), the hard disk drive interface for personal computers (PCs), the enhanced integrated drive electronics (EIDE), the improved interface to the IDE hard disk interface, the small computer system interface (SCSI), the advanced technology attachment (ATA), and the serial ATA, among others. These protocols are used to exchange information between the two or more devices.

In one embodiment, the interface 16 translates the protocols of the various storage device 14 technologies, among others, received at the first portion, to an internet small computer system interface (iSCSI) protocol for communicating over networks of one or more distributed storage frames 30, for example. The translated protocol provided at the second portion of the interface 16. According to exemplary embodiments, a system and method are provided for reducing the complexity of designing information storage solutions using the technologies described herein. The interface 16 according to various embodiments may utilize, for example, network based protocols such as the iSCSI protocol as the core of a network fabric between the storage devices 14 and their respective controllers to connect the storage device caddy 10 to the storage frame 30 and to various IP networked host computers. Those skilled in the art will appreciate that the iSCSI protocol is an Internet Protocol (IP)-based storage networking standard for linking data storage facilities. It was developed by the Internet Engineering Task Force (IETF). By carrying SCSI commands over IP networks, iSCSI is used to facilitate data transfers over intranets and to manage storage over long distances. The iSCSI protocol is one technology that may be used in the storage area network (SAN) system described herein. The iSCSI protocol increases the capabilities and performance of storage data transmission in a SAN. Due to the ubiquity of IP networks, iSCSI also may be used to transmit data over local area networks (LANs), wide area networks (WANs), or the Internet and can enable location-independent data storage and retrieval, for example.

In one embodiment, the power source for the storage device 14 may be supplied by the battery 24 or through the interface 16 via the power cable 20. Other embodiments further comprise power over Ethernet (POE) cable technology, for example. In accordance with the POE standard power to the storage device 14 may be provided from the storage frame 30 via a single cable such as, for example, the power cable 20. The POE standard allows the inclusion of a battery 24 in the same housing 12 where the storage device 14 is located. The POE standard also allows the storage frame 30 to more effectively manage power during normal operation and during power failure events by having the capability of turning off individual storage drives 14 when necessary. The battery 24 also is useful during power failures when the storage frame 30 loses main power. In these situations the battery 24 provides enough electrical energy to the storage device 14 and any associated memory buffers to complete a transaction before the storage device 14 stops operating. Also, during a power failure event, the POE interface provides enough power to the storage device 14 to perform a graceful shutdown. For example, the storage devices 14 may finish operations already in progress during the power failure by receiving a power feed through the storage frame 30 for as long as power is available through the POE interface. Furthermore, the POE interface may be used to charge the battery 24 when not in use. The POE interface also may be used to send control signals to the storage device caddy 10 so that power to it may be turned on and off to conserve energy, for example.

The connector 22 comprises, for example, a twisted pair connector. The connector 22 also supports CAT (5, 6) cable, POE connections, and/or the iSCSI interface connection, for example.

FIG. 2 illustrates one of various embodiments of a storage frame 30. The term storage frame as used herein comprises, for example, a storage silo, an automated cartridge storage (ACS) system or any other storage system comprising cartridge storage cells, transports, and some kind of robotic mechanism(s) to move the cartridges between the cells and either a transport or a pass-through port to another ACS. The storage frame 30 comprises, for example, a housing 32 and a plurality of slots 34 for receiving and containing a plurality of storage device caddies 10. The storage frame 30 also comprises a plurality of twisted pair connectors 36 such as, for example, a power connector 38, a network connector 40, a daisy chaining connector 42, and the like. The storage frame 30 also may contain an upgrade or expansion slot 44 for wireless card and fiber optic card interfaces, for example.

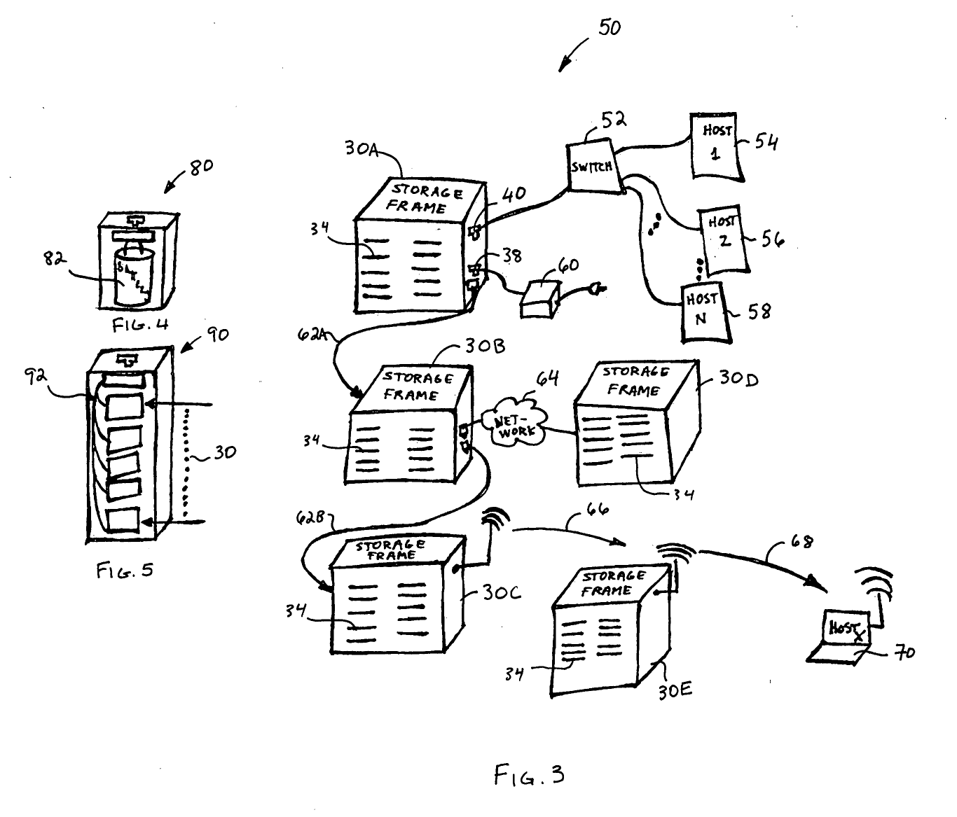

FIG. 3 illustrates a storage area network 50 (SAN) system comprising a plurality of storage frames 30A, B, C, D, E comprising a plurality of storage device caddies 10 in the various slots 34 of the storage frames 30A, B, C, D, E. As described previously, the storage device caddies 10 each contain a plurality of different storage devices 14 that communicate using a plurality of communication protocols. The storage device caddies' 10 interface 16 translates the plurality of protocols of the individual storage devices 14 to a single network protocol such that the plurality of storage frames 30A, B, C, D, E communicate over the SAN with a single network protocol. As described previously, in one embodiment, the single network protocol may be the iSCSI protocol, for example. Thus, using a single standard protocol to communicate with the SAN, the plurality of different storage devices 14 are effectively logically remapped over the SAN. For example, embodiments of the present invention provide storage frames 30A, B, C, D, E that have at least one storage device caddy 10 adapted to receive a plurality of storage devices 14 utilizing various technologies and protocols and one standard electrical connection and network protocol connection from the storage device caddy 10 to the storage frame 30A, B, C, D, E. This architecture simplifies the internal construction of each storage frame 30A, B, C, D, E. The architecture provides a single form of connection from the storage device caddy 10 to the storage frames 30A, B, C, D, E and the SAN regardless of the different types of storage devices 14 located in the storage device caddy 10 and the various respective communication protocols.

Furthermore, the storage frame 30 also may include an operating system to provide some functionality of its own. The operating system enables the storage frame 30 to detect any resources attached to it. A host computer thus may request that the storage frame 30 add or remove resources, modify read and write characteristics (e.g., data rates), reformat the storage device 14, and create a mirror, for example.

As illustrated herein, the storage frame 30A is interfaced through a switch 52 to a plurality of host computers 54, 56, 58 over the network connection 40. A power source 60 provides electrical power to the storage frame 30A via the POE interface connection 38. The storage frames 30A and 30B are daisy chained via a twisted pair cable 62A and the storage frames 30B and 30C are daisy chained via a twisted pair cable 62B. The twisted pair cables 62A, B may be, for example, CAT 6 cables. Storage frames 30B and 30D are interfaced over a network 64 such as, for example, a WAN. Storage frames 30C and 30E are interfaced via a wireless frame over a wireless protocol 66. Storage frame 30E is interfaced with a wireless host 70 via wireless protocol 68.

According to various embodiments, the storage frames 30A, B, C, D, E may be considered, for illustrative purposes, as a local SAN 50 within an enterprise wide SAN. The SAN 50, for example, mat utilize and operate with a plurality of different storage devices 14 located in respective storage device caddies 10 wherein each storage device 14 employs different technologies and communication protocols. The storage devices 14 are interfaced via a network protocol within the SAN 50 forming a portion of an enterprise wide SAN, for example. This implementation simplifies the internal construction of each storage frame 30A, B, C, D, E at least by reducing the connection from each of the storage frames 30A, B, C, D, E to the SAN 50 to a single cable (i.e., gige copper cable) over a single network protocol such as the iSCSI protocol, for example.

Existing storage frame technology such as, for example, storage silos, do not use a fabric switching protocol like the network protocol described herein in accordance with embodiments of the present invention. Rather, existing storage frame technology employs a single technology such as EIDE or SCSI, for example. In one embodiment, TCP/IP based protocols may be used to normalize the storage device 14 technologies within the storage frames 30A, B, C, D, E in addition to accessing each of the storage frames 30A, B, C, D, E within the SAN 50. In one embodiment, the standards based storage within the storage frames 30A, B, C, D, E is used to realize a plurality of different types of redundant arrays of inexpensive disks (RAID) or other storage arrangements, dynamically cascade frames together, dynamically add or remove storage and regenerate the information, and create removable information sets that can be used in standalone mode remotely from the storage frames 30A, B, C, D, E.

FIG. 4 illustrates one embodiment of an external storage frame 80 where the batteries 24 in each of the storage device caddies 10 are used to form a distributed power system. In one embodiment, this may be accomplished by returning power capacity in unused storage device caddies 10 back across the Ethernet connection to the storage frames 30A, B, C, D, E. This is schematically shown as battery 82. Thus, the external storage frame 80 can be configured to act as an uninterruptible power supply (UPS) for the storage frames 30A, B, C, D, E comprising the SAN 50.

FIG. 5 illustrates one embodiment of an external storage frame 90 comprising a plurality of storage frames 30. Each storage frame 30 is interconnected via a cable 92 (e.g., CAT 6) that carries both the iSCSI signals as well as POE signals.

Those skilled in the art will appreciate that the apparatuses and systems described above may be interconnected via many different types and variations of the communication networks, which can be a computer network or a telecommunication network. The invention is not intended to be limited to the examples of the networks described herein. Rather, the many embodiments of the present invention may be practiced in a variety of communication network operating environments including, for example, computer networks and telecommunications systems comprising packet-switches, servers, and modules capable of transmitting and receiving information in the form of packets between various devices interconnected over any predetermined computer and telecommunications networks. For example, the systems, apparatuses, and methods according to exemplary embodiments can operate in various communications environments comprise packet-switched networks, Voice over Internet Protocol (VoIP), wireless Fidelity (WiFi), Bluetooth, Ultrawideband, and other operating communications environments.

The communication networks also may include, for example, WAN, LAN, Ethernet, Internet, Web-based networks, and telecommunication networks, among others. In various environments communication may occur over computer networks interconnected via telephone lines such as a variety of digital transmission links including those provided by the local telephone company such as, for example, a digital subscriber line (DSL), an asymmetrical digital subscriber line (ADSL), a high bit rate digital subscriber line (HDSL), a single pair symmetrical services (SDSL), an integrated services digital network (ISDN) line, a T−1 digital transmission link, and/or a wireless communication line.

Although the present invention has been described with regard to certain embodiments, those of ordinary skill in the art will recognize that many modifications and variations of the present invention may be implemented. The foregoing description and the following claims are intended to cover all such modifications and variations. Furthermore, the components and processes disclosed are illustrative, but are not exhaustive. Other components and processes also may be used to make systems and methods embodying the present invention.

What is claimed is:

1. An interface, comprising:
a first portion in communication with a plurality of storage devices, wherein the plurality of storage devices use a plurality of communication protocols to exchange information between the plurality of storage devices and an external device, and
a second portion in communication with the external device;
wherein the interface translates the plurality of protocols to a network protocol prior to transmitting the information to the external device.

2. The interface of claim 1, further comprising a network connector adapted for communicating with the second portion of the interface and the external device.

3. The interface of claim 2, wherein the network connector is adapted to receive a CAT (5, 6) cable.

4. The interface of claim 1, wherein the network protocol is an iSCSI protocol.

5. The interface of claim 1, wherein the first portion of the interface is adapted for receiving the plurality of communication protocols from the plurality of storage devices and wherein the plurality of storage devices further comprises at least one of a hard disk drive, magnetic tape drive, optical disk drive, random access magnetic storage, linear access magnetic storage, flash storage, and memory.

6. The interface of claim 5, wherein the plurality of storage devices comprises at least one of a CD, CDRW, DVD, DVDRW, DVDRAM, and LD.

7. The interface of claim 5, wherein the plurality of storage devices comprises at least a random access magnetic storage comprising at least one of a HD and FDD.

8. The interface of claim 5, wherein the plurality of storage devices comprises at least a memory comprising at least one of a RAM, SDRAM, RAM disk, and RAM bus.

9. The interface of claim 1, wherein the plurality of communication protocols comprises at least one of IDE, EIDE, SCSI, ATA, and serial ATA.

10. The interface of claim 1, further comprising a power source interface.

11. The interface of claim 10, wherein the power source interface is adapted to receive a battery.

12. The interface of claim 10, wherein the power source interface is a POE interface for transferring electrical power from an external source to the plurality storage devices.

13. A system, comprising:
a plurality of storage devices for storing information thereon, wherein the plurality of storage devices use a corresponding plurality of communication protocols to transmit the information between the plurality of storage devices and an external device; and
an interface comprising a first portion in communication with the plurality of storage devices; and
a second portion in communication with the external device;
wherein the interface translates the plurality of communication protocols to a network protocol prior to transmitting the information to the external device.

14. The system of claim 13, wherein the plurality of storage devices comprises at least one of a hard disk drive, magnetic tape drive, optical disk drive, random access magnetic storage, linear access magnetic storage, flash storage, and memory.

15. The system of claim 14, wherein the optical disk drive comprises at least one of a CD, CDRW, DVD, DVDRW, DVDRAM, and LD.

16. The system of claim 14, wherein the random access magnetic storage comprises at least one of a HD and FDD.

17. The system of claim 14, wherein the memory comprises at least one of a RAM, SDRAM, RAM disk, and RAM bus.

18. The system of claim 13, further comprising a power source interface.

19. The system of claim 18, wherein the power source is a battery.

20. The system of claim 18, wherein the power source interface is a POE interface for transferring electrical power from an external source to the plurality of storage devices.

21. A system, comprising:
a first storage frame comprising a plurality of storage device caddies, wherein each device caddy further comprises:
a plurality of storage devices for storing information thereon, wherein the plurality of storage devices use a corresponding plurality of communication protocols to transmit the information between the plurality of storage devices and the first storage frame; and
an interface in communication with the plurality of storage devices, wherein the interface translates the plurality of protocols to a single network protocol prior to transmitting the information to the first storage frame.

22. The system of claim 21, wherein the first storage frame further comprises a plurality of slots for receiving the plurality of storage device caddies.

23. The system of claim 21, wherein the first storage frame further comprises a connector for interfacing the first storage frame in a SAN.

24. The system of claim 21, further comprising a second storage frame in communication with the first storage frame, wherein the first and second storage frames communicate via a common network interface and the single network protocol.

25. The system of claim 21, wherein the first storage frame further comprises a POE interface for communicating electrical power between an external device and the first storage frame.

26. The system of claim 21, wherein the first storage frame further comprises a wireless network interface for wirelessly communicating information between the first storage frame and an external device.

27. A method, comprising:
translating a plurality of storage device communication protocols to a single network protocol; and
communicating information between a plurality of storage devices using a corresponding plurality of communication protocols and an external device via the single network protocol.

28. The method of claim 27, wherein translating to a single network protocol further comprises translating to an iSCSI protocol.
